(19) United States
(12) Patent Application Publication
(10) Pub. No.: US 2024/0300047 A1
(43) Pub. Date: Sep. 12, 2024

(54) METHOD FOR CONNECTING COMPONENTS ARRANGED ON TOP OF ONE ANOTHER, COMPOSITE COMPONENT AND DEVICE FOR CARRYING OUT A CORRESPONDING METHOD

(71) Applicant: Stirtec GmbH, Premstätten (AT)

(72) Inventors: Paul Alois JARITZ, Mortantsch (AT); Mario LEITNER, Graz (AT); Thomas WEINBERGER, Graz (AT)

(73) Assignee: Stirtec GmbH, Premstätten (AT)

(21) Appl. No.: 18/574,980

(22) PCT Filed: Mar. 31, 2022
(86) PCT No.: PCT/AT2022/060100

§ 371 Date: Dec. 28, 2023

(30) Foreign Application Priority Data
Jun. 29, 2021 (AT) A 50537/2021

(51) Int. Cl. B23K 20/12; B23K 20/10; B23K 37/04; B23K 101/38

(52) U.S. Cl. CPC B23K 20/126; B23K 20/10; B23K 37/04; B23K 2101/38

(57) ABSTRACT

Method for connecting components arranged on top of one another using friction stir welding. The components are clamped using a clamping device having an opening, and connected via a friction stir welding tool protruding through the opening and rotating about an axis. To connect the components, of which at least one has a small cross section, an upper component arranged on top of a lower component protrudes into the opening along an insertion direction through a groove on an underside of the clamping device and is fixed at least partially via the groove during the friction stir welding. Further, a composite component includes a lower component and an upper component which are connected using friction stir welding. Additionally, a device for connecting two components using friction stir welding, includes a friction stir welding tool that can be rotated about an axis and a clamping device having an opening.

The invention relates to a method for connecting components arranged on top of one another using friction stir welding, the components being clamped using a clamping device having an opening, whereupon the components are connected by means of a friction stir welding tool protruding through the opening and rotating about an axis.

The invention furthermore relates to a composite component comprising an upper component and a lower component which are connected using friction stir welding.

Additionally, the invention relates to a device for connecting two components using friction stir welding, comprising a friction stir welding tool that can be rotated about an axis and a clamping device having an opening.

From the prior art, it is known that components arranged on top of one another can be connected using friction stir welding, for example using friction stir spot welding or what is referred to as refill friction stir spot welding (RFSSW).

In the methods and devices known from the prior art, it is disadvantageous that an upper component must always be embodied to be larger than the opening of a clamping device, through which opening the friction stir welding tool is guided to the components being connected, since a stable clamping of the components being connected by means of the clamping device is otherwise not enabled.

This is addressed by the invention. The object of the invention is to specify a method of the type named at the outset with which components that are arranged on top of one another can also be welded together using friction stir welding, wherein an upper component is embodied to be particularly small or has a very small extension in at least one direction.

Furthermore, a corresponding composite component is to be specified.

In addition, it is the object of the invention to specify a device for carrying out a corresponding method.

The first object is attained according to the invention with a method of the type named at the outset in which an upper component arranged on top of a lower component protrudes into the opening along an insertion direction through a groove on an underside of the clamping device and is fixed at least partially by means of the groove during the friction stir welding.

In the context of the invention, it was found that, through the use of a clamping device with a groove on the underside, a fixing of the upper component on the lower component is then also reliably possible if the upper component is embodied to be particularly small, so that the clamping device can lie flat on the lower component on the one hand, in order to prevent a lateral escape of plasticized material, and a small component can be inserted into the region of the opening through the groove on the other hand, in order to be welded to the lower component by the friction stir welding tool that protrudes into the opening. Typically, the friction stir welding tool is translationally moved along the axis during the method in order to press the components against one another and obtain a favorable connection.

The groove typically extends into the clamping device from an underside of the clamping device, but normally does not reach the upper side, even though an embodiment in which the groove protrudes all the way to the upper side of the clamping device from the underside of the clamping device is also possible.

With a method according to the invention, wires can in particular also be welded to plate-shaped components, which is advantageous for applications in the field of electromobility, for example, especially since a very favorable electrical connectivity is obtained through a friction stir-welded connection.

In contrast to conventional friction stir spot welding methods, it is, in the case of a method according to the invention, thus also possible that the upper component does not completely fill the opening in a plan view, and in particular that a base-side edge of the clamping device does not completely lie against the upper component. With a corresponding contact of the base-side edge of the clamping device, a lateral seal of a plasticizing zone is obtained in methods from the prior art, whereby it is prevented that plasticized material laterally escapes from the opening. In the method according to the invention, a corresponding seal is also rendered possible for smaller upper components. Thus, the base-side edge of the opening can be in contact with the upper component in the region of the groove, and can be in contact with the lower component in the region outside of the groove, in order to laterally seal the plasticizing zone during the welding and fix the components being connected during the friction stir welding.

It is preferably provided that, in a direction perpendicular to the axis and perpendicular to the insertion direction, the upper component has an extension that is the same size as or smaller than a diameter of the opening. In this case, the groove is typically embodied with corresponding dimensions perpendicular to the insertion direction and perpendicular to the axis, which is likewise the same size as or smaller than a diameter of the opening. The groove is typically embodied to be larger than the upper component, even though a groove with a cross section that is smaller than a cross section of the upper component is, in principle, also possible. In such a case, the upper component can be clamped in the groove and elastically and/or plastically deformed by the clamping device.

Particularly if a connection of components, of which one component has a certain flexibility, is to occur, it can be advantageous if an upper component comprising multiple individual parts, in particular stranded wires, is used. In this manner, a conductor made up of thin individual wires, a wire rope, or the like, for example, can be connected to a lower component such as a metal plate or the like, for example. A corresponding connection can, for example, be used as an electrical connection in an electric vehicle.

Because different materials, and in particular materials having different melting points, can be connected to one another with friction stir welding, a mechanically and electrically sustainable connection of a stranded wire cable made of copper to an aluminum plate or the like can thus be formed, for example.

It has proven effective that the upper component and/or the lower component comprises a coating which is thermally degraded and/or stirred into a region of a connection of the upper component and lower component by the friction stir welding. As a result, a mechanical and electrical quality of the connection can be easily influenced and, in particular, increased. For example, the lower component can be formed by a zinc-coated steel sheet and the upper component by a magnesium profile, wherein the zinc coating and the magnesium profile are stirred together in a joining zone or plasticizing zone.

To achieve a particularly good connection, it is preferably provided that, before the start of the friction stir welding, the upper component protrudes out of the groove on one side and out of the opening on the other side, after which said component is compressed by a movement of the friction stir welding tool into the opening, whereupon the upper component is connected to the lower component by friction stir welding. This has proven particularly effective for connecting non-precompacted stranded wire bundles, which can form an upper component, to a plate-shaped component, which can form a lower component.

In order to achieve a particularly good contact, it can be provided that high-frequency mechanical vibrations are additionally applied to the components.

It has proven effective that the components are additionally connected using ultrasonic welding, wherein the friction stir welding tool, the clamping device, and/or a separate component part acts as a sonotrode. The components can then be connected in equal measure using friction stir welding and using ultrasonic welding.

Sonotrode denotes a component part with which high-frequency mechanical vibrations are applied to components, which mechanical vibrations are, if necessary, used to set the components being connected in resonant vibration in order to obtain a contact and connection. The sonotrode thus produces a mechanical connection of a vibration generator, in particular an ultrasonic generator, to the components being connected. The sonotrode can be formed by a separate component, by the clamping device, and/or the friction stir welding tool. If necessary, it is also possible that only the pin or only the sleeve of the friction stir welding tool act as a sonotrode in order to obtain a connection of the components synchronously using friction stir welding and using ultrasonic welding. It is particularly preferred if the vibrations applied using the sonotrode have a frequency of more than 1 kHz, in particular more than 20 kHz, even though lower frequencies are, in principle, also possible.

A method according to the invention can be used to connect the most diverse materials. It is preferably provided that components having different melting temperatures are used, or that the method is used to connect components with different melting temperatures to one another. Of course, the method can also be used to connect components made of similar or identical materials, for example materials made of Cu-ETB.

It has proven effective that a friction stir welding tool with a melting point that is higher than a melting point of the components is used. A lower wear on the friction stir welding tool is thus achieved. For example, the friction stir welding tool can be composed of one or more of the materials steel, tungsten carbide, ceramic, nickel- or cobalt-based superalloys, or a refractory metal, or can comprise one or more of said materials.

In addition, it can be provided that the friction stir welding tool is coated on the surface, in particular with DLC, TIN, TIAIN, AlTIN, and the like.

It has proven effective that a friction stir welding tool having a pin which can be moved in an axial direction relative to a sleeve is used, wherein the pin is moved in an axial direction relative to the sleeve after a plasticizing of the upper component, so that at the end side, the pin and sleeve roughly lie in a plane perpendicular to the axis, in order to form a surface without an end hole. An end hole which appears in conventional friction stir welding can thus be easily avoided, whereby in particular an electrical resistance of a corresponding connection can be reduced. Thus, for example, the pin and sleeve are axially moved, rotating in the same direction and at the same rotational speed and spaced apart from one another in an axial direction, wherein the pin protrudes relative to the sleeve and can form a pin within the meaning of a conventional friction stir welding tool, onto the upper of the components arranged on top of one another, and are pressed onto the upper component, whereby initially the upper component and subsequently also the lower component are plasticized. Alternatively, the pin and sleeve can also be pressed onto the upper component without axial spacing, or with a spacing wherein the sleeve protrudes relative to the pin. Furthermore, it can in principle also be provided that the pin and sleeve rotate at different speeds.

Independent of whether the pin and sleeve have an axial spacing apart from one another during a plasticizing or at the start of the friction stir welding, and possibly also independent of whether the pin or sleeve protrudes axially farther, the pin and sleeve are, after the plasticizing of the components being connected and before a cooling of the plasticizing zone, preferably axially moved such that they are no longer spaced apart at an end of the friction stir welding tool that is in contact with the upper component, or such that ends of the pin and sleeve lie roughly in one plane. The pin and sleeve are then pulled out of the opening of the clamping device in an axial direction while rotating and without spacing relative to one another, so that the composite component formed from the upper component and lower component during the friction stir welding does not comprise an end hole.

In order to achieve particularly favorable mechanical and/or electrical properties, it can be provided that material is fed to a plasticizing zone during the friction stir welding, in particular via the opening and/or the groove. In this case, it can, of course, be provided that a cross section of the groove is at least slightly larger than a cross section of the upper component, so that material can be fed via a clear cross section of the groove. Of course, it can also be provided that the additionally fed material is fed through an additional opening in the clamping device.

The material fed to the plasticizing zone, that is, a zone in which the components being connected are plasticized by the friction stir welding tool, can in principle be any appropriately suitable material in any shape. For example, the material can also be fed via a wire feed, or can be placed in solid form, preferably in the form of a thin leaf or what is referred to as a billet, into a region which is plasticized during the friction stir welding. The billet can thus be placed into the opening or between the components being connected in order to achieve a stirring-in of said material.

In particular, it can be provided that material is fed in powder form in order to obtain particularly advantageous properties in the plasticizing zone through a distribution of the powder.

The fed material can correspond to the components being connected in terms of properties such as conductivity, strength, elasticity, and the like. However, it can also be provided that material which differs from the components being connected, having highly different properties, for example in terms of electrical conductivity, hardness, strength, intermetallic phases, and the like, is fed in order to influence properties of the connection in a targeted manner.

The other object is attained with a composite component of the type named at the outset, which composite component is produced in a method according to the invention. A corresponding composite component is in particular characterized in that two components are connected which can be composed of the most diverse materials, wherein one of the components can have a particularly small cross section. In particular, it can be provided that the composite component comprises an upper component and a lower component which are connected using friction stir welding, wherein the upper component is formed by a stranded wire cable.

The further object is attained according to the invention with a device of the type named at the outset, in which device the clamping device comprises a groove on an underside, with which groove an upper component arranged on top of a lower component, which upper component protrudes to the opening, can be fixed so that the upper component can be connected to the lower component by means of the friction stir welding tool positioned in the opening.

As a result of the base-side groove in the clamping device, a sealing of a plasticizing zone or of a joining zone is thus possible on the base side in the opening even if the upper component has a smaller cross section than the opening or does not completely fill the opening.

In order to prevent an escape of material from the opening during the friction stir welding in a simple manner, it is typically provided that an outer diameter of the friction stir welding tool corresponds to a diameter of the opening, wherein in particular a diameter of the opening is 0.01 mm to 5 mm larger than an outer diameter of the friction stir welding tool. The clamping device can, for example, be embodied as a plate or as a ring, wherein the opening typically has a circular cross section which corresponds to a cross section or an outer contour of the friction stir welding tool.

In principle, a method according to the invention can be carried out using any desired friction stir welding tool, that is, also with a single-piece friction stir welding tool having a pin and a shoulder. In order to produce a connection without an end hole, however, it is particularly preferably provided that the friction stir welding tool has a pin which can be moved relative to a sleeve. The pin and sleeve can then be translationally movable relative to one another in the direction of the axis, so that a smooth surface without an end hole can be obtained by pulling the pin or sleeve back while the upper component is plasticized. A surface of this type is particularly advantageous for obtaining a favorable electrical resistance.

In such an embodiment of the friction stir welding tool, it is typically provided that the pin can be positioned in a through bore in the sleeve. The sleeve can then, for example, be embodied as a hollow cylinder, wherein the pin is arranged in a through bore of the hollow cylinder. It shall be understood that, in an embodiment of this type, an outer diameter of the pin typically corresponds to an inner diameter of the sleeve embodied in a hollow cylindrical shape, in order to prevent an ingress of plasticized material in a region between the sleeve and the pin during the friction stir welding as far as possible.

Preferably, a vibration generator is provided with which high-frequency mechanical vibrations, in particular vibrations with a frequency of more than 1 kHz, preferably more than 20 kHz, particularly preferably ultrasonic vibrations, can be generated, wherein a sonotrode is provided with which the high-frequency mechanical vibrations can be transmitted to the components being connected. The components can then be connected both using friction stir welding and using ultrasonic welding, in order to obtain both a favorable mechanical and an advantageous electrical connection.

The sonotrode can, in principle, be formed by any desired component part that is connected to the vibration generator on one side and the components being connected on the other side. It is particularly preferable if the sonotrode is formed by the clamping device and/or the friction stir welding tool, in particular the pin and/or the sleeve. These component parts are in mechanical contact with the components being connected anyhow, for which reason a particularly good transmission of the vibrations is achieved in this case. Moreover, it has been shown that, through the transmission of high-frequency vibrations which are generated by a vibration generator, in particular an ultrasonic generator, a surprisingly favorable mechanical and, in equal measure, electrical connection between the components being connected can be obtained with a simultaneous friction stir welding.

Preferably, a machine table is provided against which the components can be pressed during the friction stir welding. As a result, an axial force that is advantageous for a plasticizing of the components can be applied in a stable and robust manner.

Typically, a spindle is provided with which at least a portion of the friction stir welding tool can be rotated about the axis relative to the machine table. As a rule, even in the case of a friction stir welding tool which comprises a sleeve and a pin that can be moved relative to the sleeve in order to obtain a connection without an end hole, the sleeve and pin are driven at the same speed and in the same rotation direction, so that in principle one spindle can be sufficient to set the sleeve and pin in a rotational motion about the axis. Alternatively, it can, of course, also be provided that the sleeve and pin are driven independently from one another.

For this purpose, two spindles can be provided, for example, which can be arranged coaxially in order to drive the sleeve and pin independently from one another.

The spindle can be both connected to the machine frame and embodied such that it can be moved by a separate device, in particular a robot, relative to the machine table, wherein the robot can move the spindle translationally, for example in all spatial directions, and possibly also rotationally. To implement the invention, it is, of course, also possible to provide a robot with which the components being connected and possibly the clamping device are positioned in an automated manner, after which, using said robot or another robot, in particular an electrode holder, the friction stir welding tool is accordingly moved relative to the components being connected and pressed against said components, in order to connect the components. In addition, other variants are, of course, also feasible for implementing the invention, in order to achieve a process that is, where necessary, automated and efficient.

It shall be understood that the pin and sleeve or the entire friction stir welding tool can, as a rule, be moved relative to the components being connected, independently from the clamping device.

In order to be able to axially move the friction stir welding tool and press it against the components being connected, a linear drive is preferably provided with which the friction stir welding tool can be translationally moved along the axis relative to the machine table. Of course, it can also be provided that the friction stir welding tool can be translationally moved in all spatial directions by means of a corresponding drive, in order to be able to connect components to one another at different positions on the machine table.

In order to also be able to press in an automated manner the clamping device against the components being connected, it can be envisaged that a linear drive is provided with which the clamping device can be translationally moved along the axis relative to the machine table in order to fix the components relative to the machine table.

A device that is in equal parts constructively simple and robust results if a machine frame is provided via which the friction stir welding tool is connected to the machine table, wherein the machine frame can be moved relative to the machine table. The machine frame can be translationally movable relative to the machine table in three spatial directions, for example. In particular, it can be provided that the machine frame together with the friction stir welding tool and the clamping device can be translationally moved in an axial direction relative to the machine table, or in a direction of the axis, particularly in order to press the clamping ring against the components being connected. The friction stir welding tool can, in turn, be connected to the machine frame such that said tool can be rotated about the axis and moved in an axial direction, so that the components being connected are initially clamped by means of the clamping device and then connected to one another by a movement of the friction stir welding tool in an axial direction relative to the clamping device.

For the control of the individual drives, in particular for the control of the spindle, linear drive, and machine frame, a control device having a data processing device, in particular a computer, is preferably provided.

Additional features, advantages, and effects of the invention follow from the exemplary embodiments described below. In the drawings which are thereby referenced:

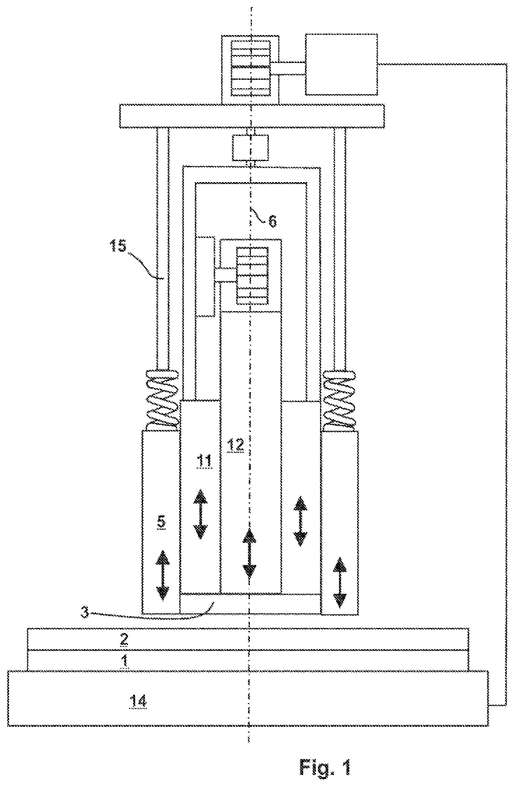

FIG. 1 shows a device for producing a friction stir-welded connection without an end hole;

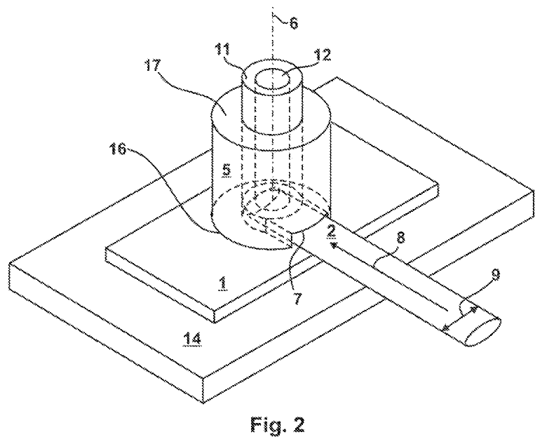

FIG. 2 shows a device;

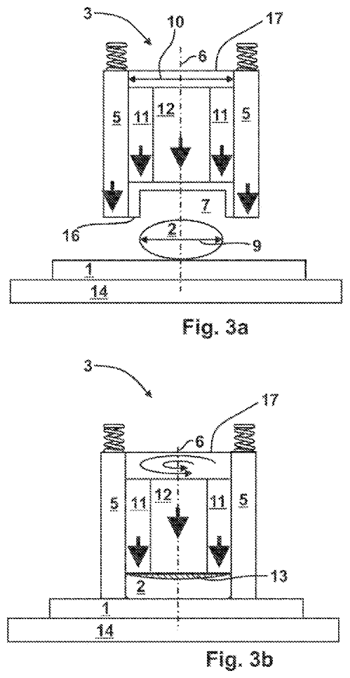

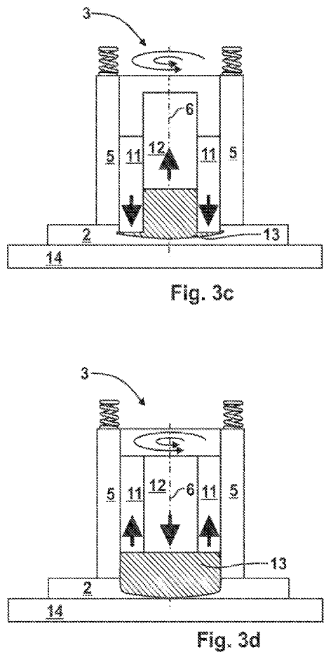

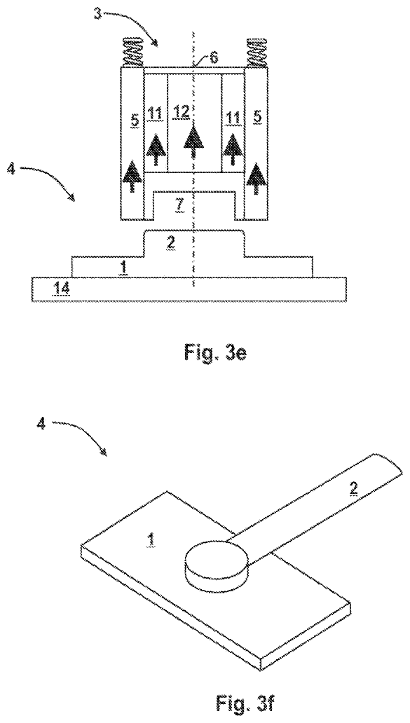

FIGS. 3a through 3f show different method steps of a method according to the invention;

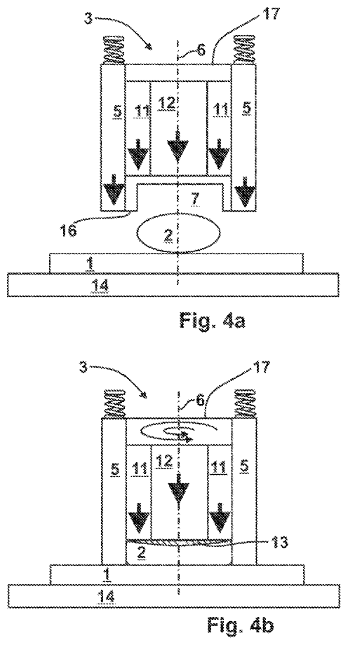

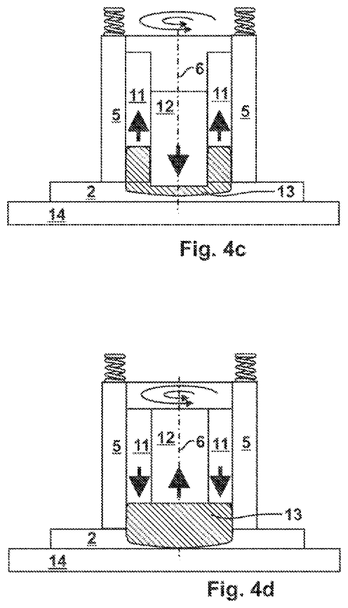

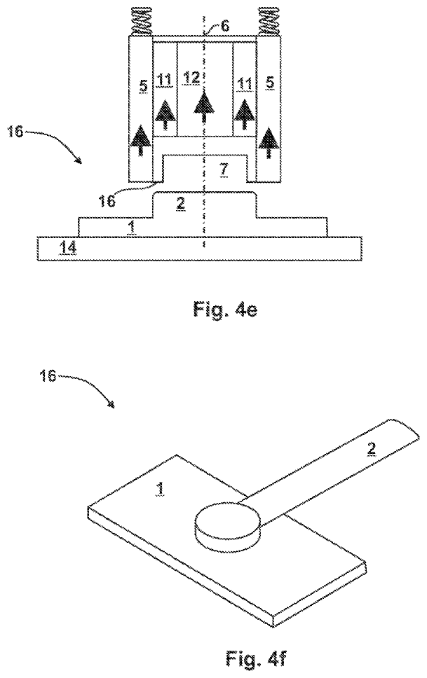

FIGS. 4a through 4f show method steps of a further method according to the invention;

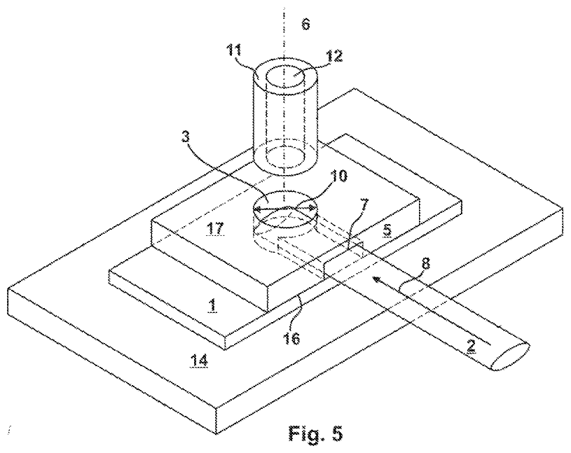

FIG. 5 shows a further device according to the invention;

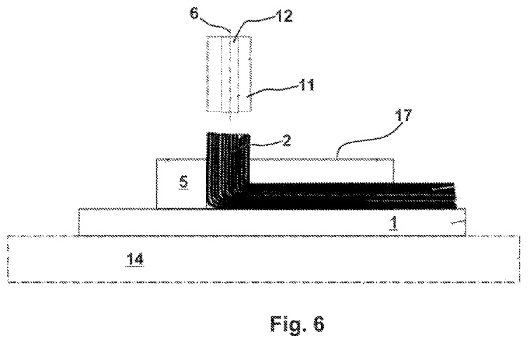

FIG. 6 shows a device according to the invention in sectional illustration;

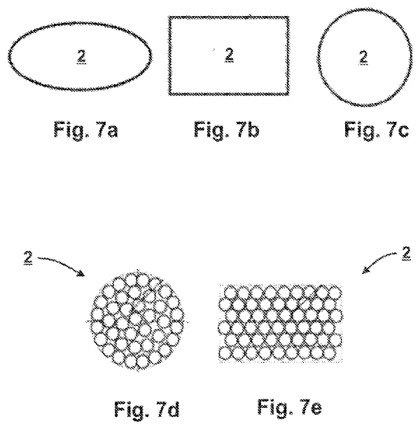

FIGS. 7a through 7e show components for a method according to the invention;

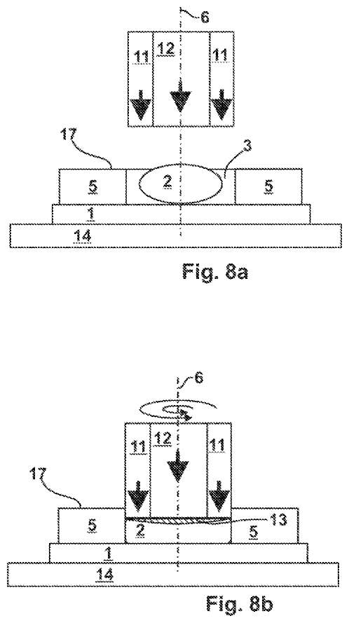

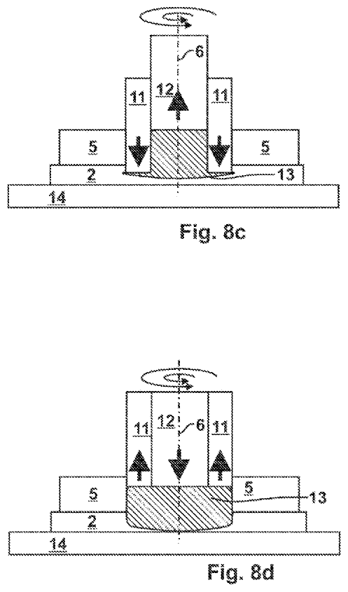

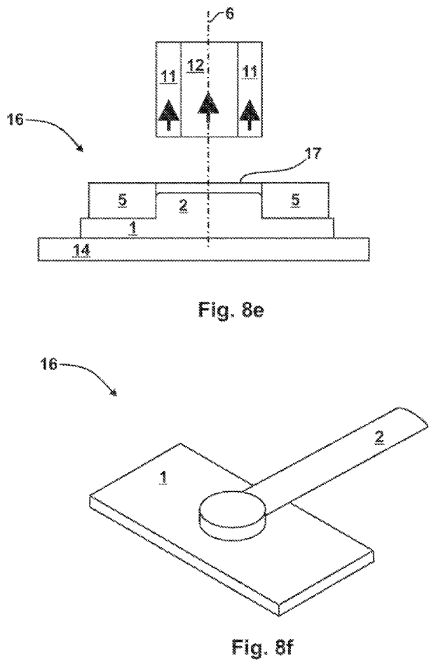

FIGS. 8a through 8f show method states of a further method according to the invention;

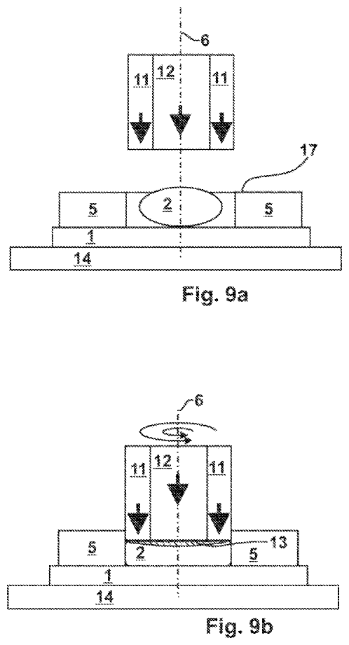

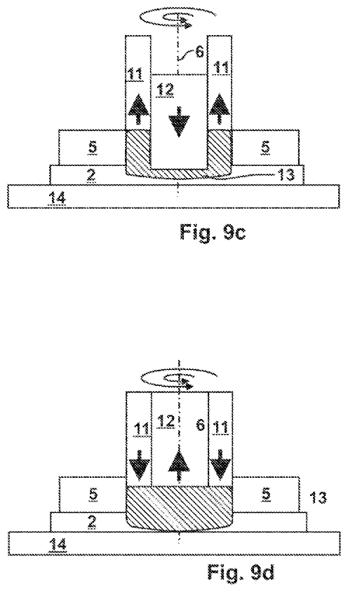

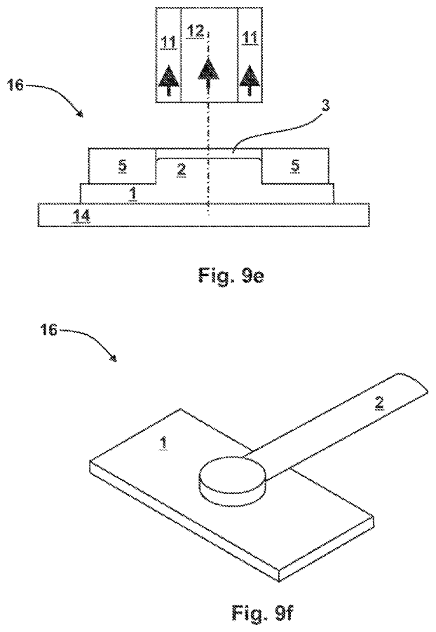

FIGS. 9a through 9f show method states of a further method according to the invention;

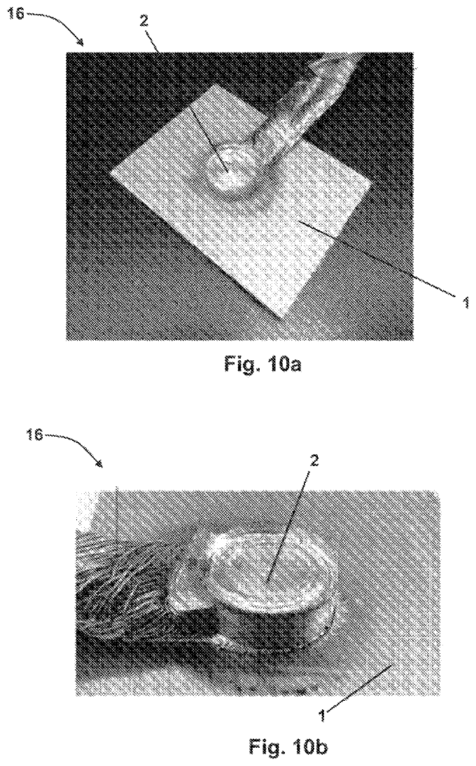

FIGS. 10a and 10b show composite components produced using a method according to the invention.

FIG. 1 shows a device from the prior art for producing a friction stir-welded connection without an end hole, or for carrying out what is referred to as a refill friction stir spot welding method. As depicted in FIG. 1. a corresponding device comprises a machine table 14 on which are positioned the components 1. 2 being connected, which are, in accordance with the prior art, typically embodied as plates, as illustrated. The device further comprises a machine frame 15 which can be moved relative to the machine table 14, in which machine frame 15 a friction stir welding tool is arranged such that it can be translationally moved along an axis 6 and rotated about the axis 6. The friction stir welding tool thereby comprises a roughly cylindrically embodied central pin 12 and a sleeve 11 formed by a hollow cylinder, which sleeve 11 surrounds the pin 12. The pin 12 and sleeve 11 can thus form the pin and shoulder of the friction stir welding tool, where in contrast to a single-piece conventional friction stir welding tool the pin 12 can be moved relative to the sleeve 11 in this case. As a result, the pin 12 can be pulled back into the sleeve 11 far enough that the pin 12 and sleeve 11, as illustrated in FIG. 1, terminate in an approximately flush manner at an end side, that is, at a lower end facing the components 1, 2.

In order to prevent a lateral escape of plasticized material, a clamping device 5 formed in this case by a clamping ring movably connected to the machine frame 15 is provided, which clamping device 5 surrounds the friction stir welding tool and seals a plasticizing zone at a lower end of the friction stir welding tool during the method. Thus, the clamping device 5 is in this case likewise embodied as a hollow cylinder, wherein the friction stir welding tool is arranged in a central opening 3 of this hollow cylinder.

In a conventional method, the clamping ring is thus first fitted onto an upper component 2, whereupon the friction stir welding tool, which is translationally movable along the axis 6 relative to the machine frame 15 and formed by the pin 12 and sleeve 11, is lowered into the opening 3 and thereby rotated about the axis 6, in order to connect the components 1, 2 to one another using friction stir welding.

As can be seen, a device of this type is not suitable for connecting components 1, 2 to one another in which an upper component 2 does not completely fill the opening 3 of the clamping device 5, especially since a seal of the plasticizing zone 13 would otherwise not be ensured.

In order to overcome this disadvantage, a groove 7 is provided according to the invention on an underside 16 of the clamping device 5 in a device illustrated in FIG. 2, through which groove 7 an upper component 2 can be laterally inserted into the opening 3. As can be seen, the clamping device 5 can, laterally from the upper component 2, lie flat against the lower component 1 and thus seal the plasticizing zone 13 well, so that a stable connection can be obtained even if the upper component 2 has a smaller cross section than the opening 3. The upper component 2 can in this case be inserted into the groove 7 along an insertion direction 8 and has, in a transverse direction that is perpendicular to the insertion direction 8 and perpendicular to the axis 6, an extension 9 that is smaller than a diameter 10 of the opening 3.

FIGS. 3a through 3f show different method states of a method according to the invention using the device illustrated in FIG. 2. One again, a machine table 14 is provided against which the components 1, 2 being connected are pressed, wherein the clamping device 5 and the friction stir welding tool once again formed by a central pin 12 and a sleeve 11 surrounding the pin 12 can be moved via a machine frame 15 that is not illustrated and can be moved relative to the machine table 14.

As can be seen in FIG. 3a, the upper component 2 is first positioned on top of the lower component 1, after which a clamping of the upper component 2 in the groove 7 occurs using a translational displacement of the clamping device 5 along the axis 6. The upper component 2 can thereby also be plastically or elastically deformed in the groove 7, so that the upper component 2 can also completely fill the groove 7. A groove base thus rests on the upper component 2, and groove side surfaces laterally bear against the upper component 2. A footprint or underside 16 of the clamping device 5 lies flat against the bottom component 1 in the method states illustrated in FIGS. 3b through 3d.

In the method state illustrated in FIG. 3b, the pin 12 and sleeve 11 are displaced downwards together along the axis 6. Through a simultaneous rotation of the pin 12 and sleeve 11, which typically rotate about the axis 6 at the same speed and in the same rotation direction, the components 1, 2 being connected are heated and plastically deformed, so that a plasticizing zone 13 develops. In a further method step illustrated in FIG. 3c, the sleeve 11 is lowered farther along the direction of the axis 6, and the pin 12 is slightly raised in the opposite direction, so that the upper component 2 is connected to the lower component 1 using friction stir welding. As can be seen, a cavity or a hollow space forms below the pin 12 and in the sleeve 11 as a result of the relative displacement of the pin 12 and sleeve 11, into which cavity the plasticized material is moved so that the cavity is filled by the plasticized material.

In the method state illustrated in FIG. 3d, the sleeve 11 has been raised again and the pin 12 lowered again, so that the pin 12 and sleeve 11 form an approximately flat plane at a lower end, namely even before the plasticized material has solidified again. As a result, a smooth surface of the composite component 4 is obtained in the region in which the friction stir welding tool has acted on the upper component 2.

In a further method step illustrated in FIG. 3e, the clamping device 5 together with the friction stir welding tool formed by the sleeve 11 and pin 12 are raised, whereby the connection as depicted in FIG. 3f is complete. As can be seen here, the result is a composite component 4 which comprises the upper component 2 connected to the lower component 1, wherein the connection is free of an end hole. Favorable mechanical and electrical properties are thus obtained.

FIGS. 4a through 4e show a further method according to the invention, which method is implemented essentially analogously to the method steps illustrated in FIGS. 3a through 3f. In contrast to the method depicted in FIGS. 3a through 3f, however, for the formation of the friction stir-welded connection, it is not the sleeve 11 which is lowered and the pin which is raised 12, but rather precisely the opposite, with the pin 12 being lowered and the sleeve 11 being raised, as can be seen in FIG. 4c. In this case, the cavity thus forms laterally from the pin 12 and below the sleeve 11, and not inside of the sleeve 11 as depicted in FIG. 3c.

In the method state illustrated in FIG. 4c, the sleeve 11 and pin 12 thus constitute a tool corresponding to a conventional friction stir welding tool with a shoulder and pin. Here, too, a smooth surface, or a surface without an end hole, is obtained in a subsequent method step, in that the pin 12 and sleeve 11 are moved in an axial direction such that they form at the end side an essentially flat plane while the upper component 2 is still heated or deformable, as can be seen by reference to the plasticizing zone 13 also illustrated in FIG. 4d. Following production of the composite component 4, the friction stir welding tool together with the clamping device 5 is raised again by means of a machine frame 15, not illustrated, as can be seen in FIG. 4e. As depicted in FIG. 4f, a composite component 4 with a surface having no end hole in the region of the friction stir-welded connection is once again obtained.

FIG. 5 shows a further device according to the invention. In contrast to the device depicted in FIG. 2 through FIG. 4e, the clamping device 5 is in this case not formed by a clamping ring, but rather by a clamping plate, which in turn comprises a top-side opening 3 and a groove 7 protruding into a region of the opening 3, through which groove 7 an upper component 2 having a smaller cross section than the opening 3 can be inserted into the region of the opening 3.

A diameter 10 of the opening 3, which in this case also extends from an upper side 17 to an underside 16 of the clamping device 5, essentially corresponds to an outer diameter of the friction stir welding tool once again formed by a sleeve 11 and a pin 12, or a diameter 10 of the opening 3 is typically 0.01 mm to 5 mm larger than an outer diameter of the sleeve 11 or of the friction stir welding tool, in order to enable a wear-free rotation of the friction stir welding tool in the opening 3 of the clamping device 5 on the one hand and to prevent an escape of material through the opening 3 during the friction stir welding on the other hand.

As can be seen, the groove 7 in this case protrudes upwards from an underside 16 of the clamping device 5, and in this case does not extend from an underside 16 to an upper side 17 of the clamping device 5, even though an embodiment of this type is, in principle, also possible. The groove 7 can then also be embodied as a continuous notch.

FIG. 6 shows a sectional illustration through a device according to the invention, according to FIG. 5 while a method according to the invention is being carried out, wherein the upper component 2 is formed by a stranded wire bundle. FIG. 6 shows a method step in which the upper component 2 formed by the stranded wire bundle has already been fixed on the lower component 1 using the clamping device 5, before the friction stir welding tool once again formed by the pin 12 and sleeve 11 was lowered by means of a machine frame 15, not illustrated, onto the components 1. 2 being connected. As can be seen, the stranded wire bundle forming the upper component 2 in this case protrudes out of the opening 3 by an excess length past the upper side 17 of the clamping device 5. By lowering the friction stir welding tool, a compacting of the stranded wire bundle in the opening 3 is thus also possible, whereby a particularly good mechanical and electrical connection can be obtained.

FIGS. 7a through 7e show by way of example components 1, 2 which can be used as upper components 2 in a method according to the invention. As can be seen in FIGS. 7a through 7c, the upper component 2 can be formed by a single component with different rectangular and round cross sections. As can be seen in FIGS. 7d and 7e, the upper component 2 can also be formed by a stranded wire bundle, wherein the stranded wire bundle can likewise have both a round and a rectangular cross section.

FIGS. 8a through 8f show different method states of a method according to the invention, which method is implemented using the device illustrated in FIG. 5. As can be seen, the upper component 2 is in this case first fixed on the lower component 1 using the clamping device 5, wherein the upper component 2 and the lower component 1 are pressed against the machine table 14. In a further method step illustrated in FIG. 8b, the sleeve 11 and pin 12 of the friction stir welding tool are lowered and simultaneously rotated in order to heat and plasticize the components 1, 2, whereby a plasticizing zone initially forms at the upper component.

Analogously to the methods illustrated in FIGS. 3a through 3f, the sleeve 11 is first lowered and the pin 12 raised in this case, wherein plasticized material is pressed in a region of a cavity between the sleeve 11 and pin 12, after which the pin 12 is lowered and the sleeve 11 raised in order to achieve a flat surface. It shall be understood that, in between the individual method steps, a delay time can also be provided in order to achieve a good stirring of the components 1, 2 being connected. In particular, a delay time can be provided in between the method steps illustrated in FIGS. 8c and 8d, in which delay time the sleeve 11 and pin 12 of the friction stir welding tool are rotated in a corresponding axial direction, if necessary accompanied by an application of a constant or varying pressure in an axial direction.

In between the method steps illustrated in FIGS. 8a and 8d, material can be fed to the plasticizing zone 13, in which the components 1. 2 being connected are plasticized, via the opening 3 or via the groove 7, for example. This, of course, also applies analogously to the other exemplary embodiments described herein.

FIGS. 9a through 9f show method steps of a further method according to the invention, which method is implemented using the device according to the invention, illustrated in FIG. 5. Analogously to the method illustrated in FIGS. 4a through 4e, the pin 12 is in this case lowered and the sleeve 11 raised, as evident in FIG. 9c, and a cavity forms laterally from the pin 12 between the pin 12, the sleeve 11, and the clamping device 5, after which the sleeve 11 and pin 12 are in turn moved into the same axial position in order to obtain a flat surface.

FIGS. 10a and 10b show photographs of composite components 4 produced in a method according to the invention. The composite components 4 each comprise a lower component 1 formed by a copper plate and an upper component 2 formed by a stranded wire cable. As can be seen, the composite component 4 has in the region of the friction stir-welded connection an essentially cylindrical contour which corresponds to a diameter 10 of the opening 3 of the clamping device 5. It can furthermore be seen that a face in the region of the friction stir-welded connection is embodied without an end hole, which embodiment is obtained through the use of the two-piece friction stir welding tool formed by the pin 12 and sleeve 11.

With a method according to the invention, the connection of components 1, 2 using friction stir welding is then also possible if one of the components 1, 2 has a very small cross section. A composite component 4 produced in such a manner can in particular be used for electrical connections, wherein components 1, 2 made of different materials or having different melting points can also be connected. The pin and sleeve of the friction stir welding tool typically have a melting point which is higher than a melting point of the components being connected.

1. A method for connecting components arranged on top of one another using friction stir welding, the components being clamped using a clamping device having an opening, whereupon the components are connected by a friction stir welding tool protruding through the opening and rotating about an axis, wherein an upper component arranged on top of a lower component protrudes into the opening along an insertion direction through a groove on an underside of the clamping device and is fixed at least partially by the groove during the friction stir welding.

2. The method according to claim 1, wherein in a direction perpendicular to the axis and perpendicular to the insertion direction, the upper component has an extension that is the same size as or smaller than a diameter of the opening.

3. The method according to claim 1, wherein an upper component comprising multiple individual parts, in particular stranded wires, is used.

4. The method according to claim 1, wherein before the start of the friction stir welding, the upper component protrudes out of the groove on one side and out of the opening on the other side, after which said component is compressed by a movement of the friction stir welding tool into the opening, whereupon the upper component is connected to the lower component by friction stir welding.

5. The method according to claim 1, wherein high-frequency mechanical vibrations are additionally applied to the components.

6. The method according to claim 5, wherein the components are additionally connected using ultrasonic welding, wherein the friction stir welding tool, the clamping device, and/or a separate component part acts as a sonotrode.

7. The method according to claim 1, wherein components having different melting temperatures are used.

8. The method according to claim 1, wherein the upper component and/or the lower component comprises a coating which is thermally degraded and/or stirred into a region of a connection of the upper component and lower component by the friction stir welding.

9. The method according to claim 1, wherein a friction stir welding tool with a melting point that is higher than a melting point of the components is used.

10. The method according to claim 1, wherein a friction stir welding tool having a pin which can be moved in an axial direction relative to a sleeve is used, wherein the pin is moved in an axial direction relative to the sleeve after a plasticizing of the upper component, so that at the end side, the pin and sleeve roughly lie in a plane perpendicular to the axis, in order to form a surface without an end hole.

11. The method according to claim 1, wherein material is fed to a plasticizing zone during the friction stir welding, in particular via the opening and/or the groove.

12. The method according to claim 11, wherein material is fed in powder form.

13. A composite component comprising a lower component and an upper component which are connected using friction stir welding, wherein the composite element is produced in a method according to claim 1.

14. A device for connecting two components using friction stir welding, in particular for carrying out a method according to claim 1, comprising a friction stir welding tool that can be rotated about an axis and a clamping device having an opening, wherein the clamping device comprises a groove on an underside, with which groove an upper component arranged on top of a lower component, which upper component protrudes to the opening, can be fixed so that the upper component can be connected to the lower component by the friction stir welding tool positioned in the opening.

15. The device according to claim 14, wherein an outer diameter of the friction stir welding tool corresponds to a diameter of the opening, wherein in particular a diameter of the opening is 0.01 mm to 5 mm larger than an outer diameter of the friction stir welding tool.

16. The device according to claim 14 or 15, wherein the friction stir welding tool comprises a pin that can be moved relative to a sleeve.

17. The device according to claim 16, characterized in that the pin can be positioned in a through bore in the sleeve.

18. The device according to claim 14, wherein a vibration generator is provided with which high-frequency mechanical vibrations, in particular ultrasonic vibrations, can be generated, wherein a sonotrode is provided with which the high-frequency mechanical vibrations can be transmitted to the components being connected.

19. The device according to claim 14, wherein the sonotrode is formed by the clamping device and/or the friction stir welding tool, in particular the pin and/or the sleeve.

20. The device according to claim 16, wherein a machine table is provided against which the components can be pressed during the friction stir welding.

21. The device according to claim 20, wherein a spindle is provided with which at least a portion of the friction stir welding tool can be rotated about the axis relative to the machine table.

22. The device according to claim 20, wherein a linear drive is provided with which the friction stir welding tool can be translationally moved along the axis relative to the machine table.

23. The device according to claim 20, wherein a linear drive is provided with which the clamping device can be translationally moved along the axis relative to the machine table in order to fix the components relative to the machine table.

24. The device according to claim 20, wherein a machine frame is provided via which the friction stir welding tool is connected to the machine table, wherein the machine frame can be moved relative to the machine table.
